(19) United States
(12) Patent Application Publication
(10) Pub. No.: US 2008/0109156 A1
(43) Pub. Date: May 8, 2008

(54) SYSTEM AND METHOD FOR A 3-DIMENSIONAL MATRIX VIRTUAL TRAVEL AGENT TO CUSTOMIZE A SEQUENTIAL MULTI-DESTINATION ROUTE TRIP

(76) Inventor: John JeongHo Park, Alexandria, VA (US)

Correspondence Address: DAVID H. LEE, 6606 SCHURTZ ST., ALEXANDRIA, VA, 22310, US

(21) Appl. No.: 11/419,220

(22) Filed: May 19, 2006

(51) Int. Cl. G01C 21/00

(52) U.S. Cl. 701/201; 701/202

(57) ABSTRACT

A 3-Dimensional matrix virtual travel agent for business and leisure travelers to customize sequential multi-destination route trip is disclosed. The system comprises a Web based 3-Dimensional matrix consisting axes of departure city, arrival city, and travel services that provide a customized sequential multi-destination route travel service. A traveler may easily search all possible multi-destination travel places substituting a number of cases of each sequential route, and make a customized travel itinerary.

### TECHNICAL FIELD

The present invention generally relates to Web-based travel service systems and more particularly to schedule and reservation systems of dynamic multi-destination route travel defined by traveler customized profiles.

### BACKGROUND OF THE RELATED ART

With the growing popularity of the Internet and the Web technology, many business and leisure travelers are employing online sources as the scheduling and reservation tool for expected travel. Numerous Web-based systems of travel scheduling and reservation are available for both business and leisure travelers across the Internet. Commonly, the systems provide various types of travel factors regarding a destination city specified by the traveler such as flights, hotels, rental cars, restaurants, activities, and other factors. Especially, the flight scheduling information consisting of departure city, arrival city, and fare of the flight etc. is very important factor in the system. Presently, the existing Web-based travel service systems are divided with two kinds of prototype. While one is a static point-to-point destination model, the other one is a static multiple destination model.

First of all, the static point-to-point destination model among the Web-based travel service systems operates to provide reservation information and process of flights, hotels, and rental cars. The model has a quite simple and popular system that just provides the travel reservation of one destination per each session. If a traveler wants to get the other travel information or reservation, one should input the other destination as a new session. With the static point-to-point destination model, the business and leisure travelers who should register multiple destination routes for the trip have to search and reserve flights, hotels, rental cars etc. for the each destination. Also, it is difficult to figure out multi-destination trips, such as more than three destinations, at a glance.

The other model of the Web-based travel scheduling and reservation system is a static multi-destination model. Only some of the general Web-based travel scheduling and reservation systems are recently providing this multi-destination model for business and leisure travelers who wants to make schedule and reservation for multiple destinations at once. Through this model, travelers can select and reserve multiple destinations at once, but this model is called static model not dynamic model due to several reasons.

First, this model is a travel scheduling and reservation system not making a sequential multiple destination route but providing a discrete multiple destination route. The model still searches the expected flight airline information between two destinations, but the information is not related with the other destination routes. In other words, the traveler only makes reservation of two points on the multi-destination travel route per each session. Second, the static multi-destination model does not consider number of cases for the order of the multiple travel destinations. A traveler has to previously decide the order of the multiple travel destination route, and can not compare the other number of cases for the other possible routes. It is very confusing for a traveler to decide which route of travel destination is optimal associated with several factors, such as cost, traveling time, and travel purpose. Third, the process of making the static multi-destination scheduling and reservation system is not flexible. When a traveler wants to change, add, or drop the sequence of multiple travel destinations, it is very difficult and complicated to correct and modify whole travel plan again. Fourth, the existing static multi-destination scheduling and reservation systems do not customize a sequential multiple route associated with available travel service factors, such as hotels, rental cars, restaurants, and activities.

Accordingly, there remains a need in the system for a 3-Dimensional matrix virtual travel agent that allows a business and leisure travelers to make scheduling and reserving sequential route trips for multiple destinations at once. Further, the 3-Dimensional matrix virtual travel agent is needed to calculate and figure out the number of cases of travel routes for the multiple destinations. In addition, the new agent is needed a function that can correct and modify the travel routes for the multiple destination flexibly and dynamically. Finally, the 3-Dimensional matrix virtual travel agent is needed to customize a sequential multiple travel route associated with travel service factors as the travel scheduling and reservation process.

### SUMMARY OF THE INVENTION

The present invention is directed to a system and method of a 3-Dimensional matrix virtual travel agent that substantially improves the shortcomings and disadvantages of the existing Web-based travel service systems. According to particular embodiments, the system and method enable the web-based virtual travel agent to automatically build a 3-Dimensional matrix for travel scheduling and reservation for sequential multiple destination route trip. The business and leisure travelers who want to visit several destination places for a trip need to make a sequential multiple destination route planner and reservation. Since there are many destinations and factors, the travelers consider making a scheduler as an itinerary form as well.

In one aspect, there is a system and method of 3-Dimensional matrix consisting of three travel axes including multiple departure cities, multiple arrival cities, and travel services as factors. When a traveler chooses multiple travel cities as destination routes, the 3-D matrix agent arranges these destinations on each one of the axes and virtually shows the available travel services for the each arriving city.

In another aspect, the 3-Dimensional matrix virtual travel agent figures out a number of cases for the multiple destination route. If there are n cities as destination routes, the number of cases for the routes is (n−1)! choices. For instance, if there are 5 destination routes, A, B, C, D, E, the city A has 4 choices to consider going, city B has 3 choices, and so forth. Therefore, in this example, (5−1)!=24 numbers of cases are available as sequential multi-destination travel route. The 3-Dimensional matrix virtual travel agent arranges a sequential multi-destination travel route for each of the number of cases of the destination cities.

In another aspect, the 3-Dimensional matrix virtual travel agent makes schedule and reservation match the selected sequential multi-destination travel route with several travel services, such as flights, hotels, rental cars, restaurants, and activities. The agent uses a relational database consisting destination, travel services, scheduling, reservation, and traveler information. The result of the scheduling and reservation made in the relational database become a customized itinerary for the multi-destination travel route for business and leisure travelers.

Other systems, methods, features and advantages of the invention will be apparent to one with skill in the art upon examination of the following figures and detailed descriptions, and claims provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a layout of the 3-Dimensional matrix of the virtual travel agent in accordance with an embodiment of the present invention.

FIG. 2 is a sequential multi-destination travel route with the customized matrix of the virtual travel agent in accordance with an embodiment of the present invention.

FIG. 3 is a logical diagram that depicts the number of cases of multi-destination route as an example.

FIG. 4 is a tour detailed 3-Dimensional sequential matrix generated with practical example of flight information in accordance with an embodiment of the present invention.

FIG. 5 is a tour detailed 3-Dimensional sequential matrix generated with practical example of travel service axis in accordance with an embodiment of the present invention.

FIG. 6 is a schematic diagram of an exemplary 3-Dimensional matrix virtual travel agent system in accordance with an embodiment of the invention.

FIG. 7 is a logical flow diagram that depicts the operations which are performed by a 3-Dimensional matrix virtual travel agent in accordance with an embodiment of the present invention.

### DETAILED DESCRIPTION OF THE PREFERRED EMBODIMENT

Reference will now be made in detail to the embodiments of the present invention, example of which are illustrated in the accompanying drawings.

The present application describes a comprehensive system and method for enabling business and leisure travelers to schedule and reserve sequential multiple destination route trips using a 3-Dimensional matrix virtual travel agent. An example of multiple destination route travelers may be people who desire to drop by multiple cities in a trip for a business and leisure purpose. The 3-Dimensional matrix virtual travel agent may utilize the system to develop a customized sequential multiple destination route trip framework and a resulting number of cases for possible route. The framework of the customized sequential multiple destination route trip may include 3-Dimensional axes which are departure cities, arrival cities, and travel reservation services such as flights, hotels, rental cars, restaurants, and activities. To use the 3-Dimensional matrix virtual travel agent, the travelers may access a user interface of a travel Website. Using the virtual travel agent, the travelers may enter personal information, travel duration, and number of travelers for the expected travel in the user interface.

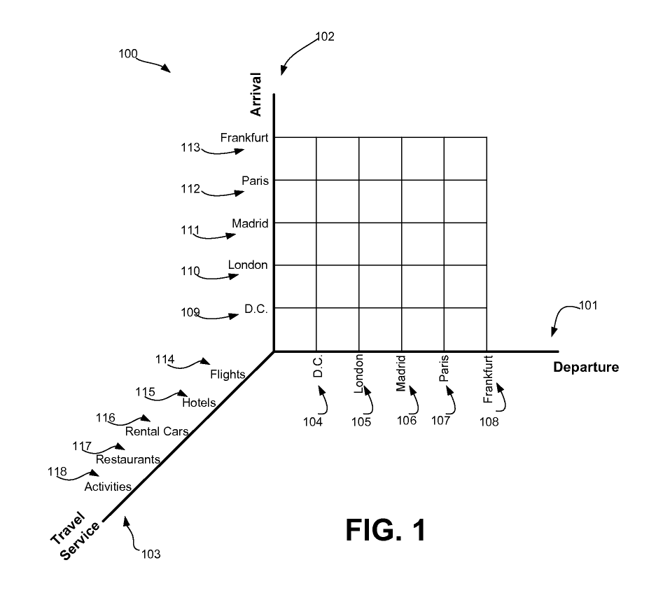

FIG. 1 illustrates one embodiment of a system 100 for building a 3-Dimensional matrix that includes departure city axis 101, arrival city axis 102, and travel service axis 103. Departure cities 104, 105, 106, 107, and 108 and arrival cities 109, 110, 111, 112, and 113 request customized input from a traveler into a 3-Dimensional matrix virtual travel agent. The departure cities 104, 105, 106, 107, and 108 and arrival cities 109, 110, 111, 112, and 113 are identical and same order according to traveler's multiple destination input. The far left city 104 on the departure axis 101 is indicated starting point of the multi-destination route trip even though the rest of the multiple cities 105, 106, 107 and 108 may be ordered by the traveler. At the same time, the city 109 of the lowest part on the arrival axis 102 is indicated ending point of the multi-destination route trip. The third axis 103 of the 3-Dimensional matrix 100 represents available travel services for the traveler to choose and link to each destination of multiple route.

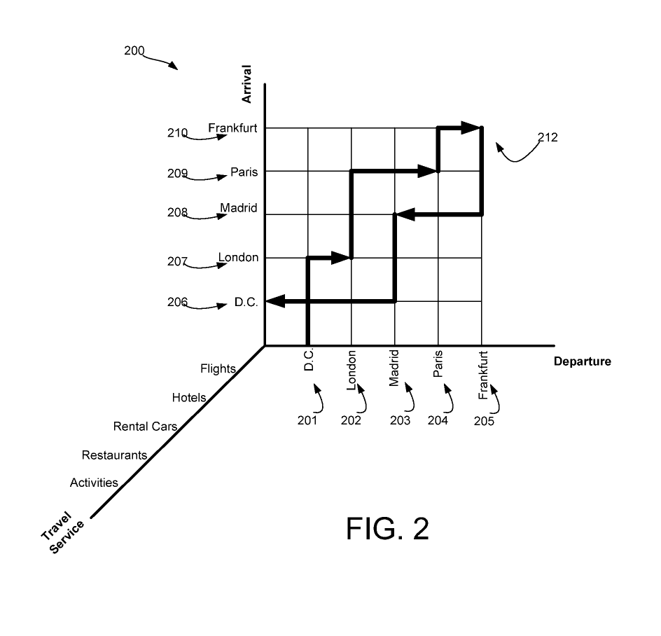

FIG. 2 is a layout 200 illustrating exemplary of a sequential multi-destination travel route 212 for the customized matrix of the virtual travel agent. In this example, a business or leisure traveler chooses Washington D.C. 201 as an initial departure city, and arranges four more cities 202, 203, 204, and 205 as desired cities to visit. In other words, the traveler once chooses the multi-destination travel route like following in this case: Washington D.C. → London → Paris → Frankfurt → Madrid → Washington D.C. When the traveler makes order of the travel plan, the 3-Dimensional matrix virtual travel agent customizes and displays the initial sequential multi-destination route 212 on a user interface of the traveler. With the sequential multi-destination route 212, a traveler makes a schedule to depart from Washington D.C. 201 and arrive to London 207. After that, the traveler makes a sequential travel schedule of a series set R like (r_{WL}, r_{LP}, r_{PF}, r_{FM}, r_{MW}) when r_{AB} means route from A departure city to B arrival city. Also W, L, P, and Fin this example mean wahington D.C 201 and 206, London 202 and 207, Madrid 203 and 208, Paris 204 and 209, and Frankfurt 205 and 211 in order. The sequential travel schedule of the series set indicates that the traveler travels from one departure city to one arrival city. The sequential multi-destination travel route 212 presents multiple routes at once, so it is easy for the traveler to make travel schedule.

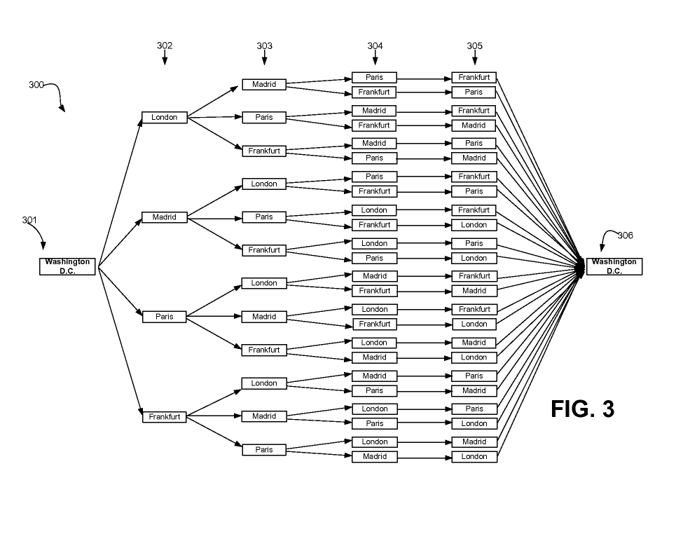

FIG. 3 is a logical diagram 300 that depicts the number of cases of multi-destination route as an example. The number of cases for a multi-destination travel route can be figured by (n−1)!=(n−1)×(n−2) . . . 2×1 when the n is number of travel destination including the initial starting city. In the example of the FIG. 3, the number of cases is 24 sequential routes which are (5−1)!=4×3×2×1. Washington D.C. 301 on the left side indicates the initial starting point for the multi-destination travel route while the Washington D.C. 306 on the right side indicates final returning point for the travel route. The second column 302 on the logical diagram 300 illustrates the possible number of cases that the traveler chooses a city as an arrival city from Washington D.C. 301.

Since the first departure city 306, Washington D.C. in this case, is a fixed factor, the traveler has 4 choices (n−1) for the next destination city 302. The set of the first route R₁ consists of (r_{WL}, r_{WM}, r_{WP}, r_{WF}) in a sequential order. For the third column 303 on the logical diagram 300, there are 3 choices (n−2) for each departure cities 302. Therefore, the number of cases of the third column 303 is 12 multi-destination route travels of the series set. The series set of the second route R₂ consists of {(r_{WL}, r_{LM}), (r_{WL}, r_{LP}), (r_{WL}, r_{LF}), . . . , (r_{WF}, r_{FL}), (r_{WF}, r_{FM}), (r_{WF}, r_{FP})}. At the same method, the fourth column 304 on the logical diagram 300 has 2 choices (n−3) for each departure city 303, and 24 total multi-destination route travel of series sets for the traveler to choose. The series set of the third route R₃ consists of {(r_{WL}, r_{LM}, r_{MP}), (r_{WL}, r_{LM}, r_{MF}), (r_{WL}, r_{LP}, r_{PM}), . . . , (r_{WF}, r_{FM}, r_{MP}), (r_{WF}, r_{FP}, r_{PL}), (r_{WF}, r_{FP}, r_{PL})}. For the last column 305 of the logical diagram 300 has just one choice (1) for each departure city 304, and the same 24 total multi-destination route travel of series sets since the destination cities of the last column have only one choice left. The series set of the fourth route R₄ consists of {(r_{WL}, r_{LM}, r_{MP}, r_{PF}), (r_{WL}, r_{LM}, r_{MF}, r_{FP}), (r_{WL}, r_{LP}, r_{PM}, r_{MF}), . . . , (r_{WF}, r_{FM}, r_{MP}, r_{PL}), (r_{WF}, r_{FP}, r_{PL}, r_{LM}), (r_{WF}, r_{FP}, r_{PM}, r_{ML})}. Also, Washington D.C. 306 is a final returning city of the multi-destination route travel, so it doesn't affect total number of cases of the travel.

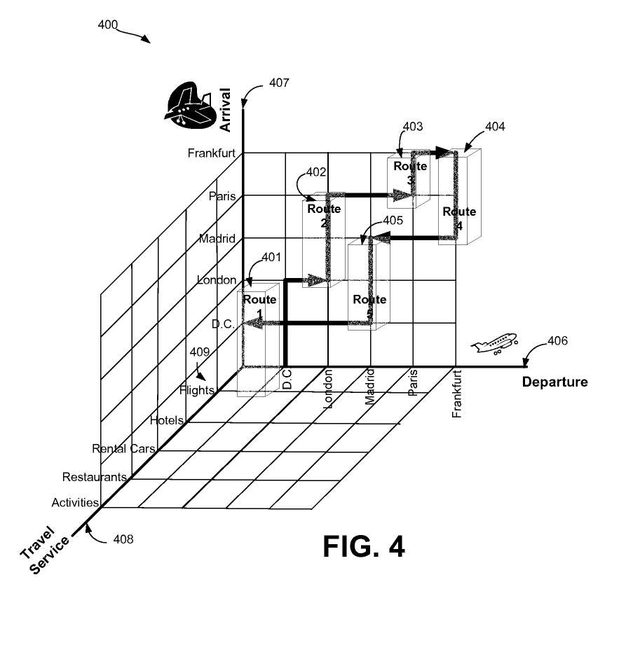

FIG. 4 is a tour detailed 3-Dimensional sequential matrix 400 generated with practical example of flight information 409 as the first main factor of the travel service axis 408 matched with the departure axis 406 and the arrival axis 407. In this stage, a traveler may get detailed air flight information 409 according to the sequential multi-destination routes 401, 402, 403, 404, and 405. Each air flight information including availability of airline, departure time and arrival time of each route, air flight fare, and distance between two routes. The traveler may modify the sequential multi-destination routes 401, 402, 403, 404, and 405 anytime for getting optimal solution for the travel purpose. For instance, the route 1 401 provides detailed air flight information about the travel series set such as (Washington D.C., London). Whenever the traveler changes the sequential route order to another way, the 3-Dimensional sequential matrix 400 dynamically changes the dedicated route information for the traveler.

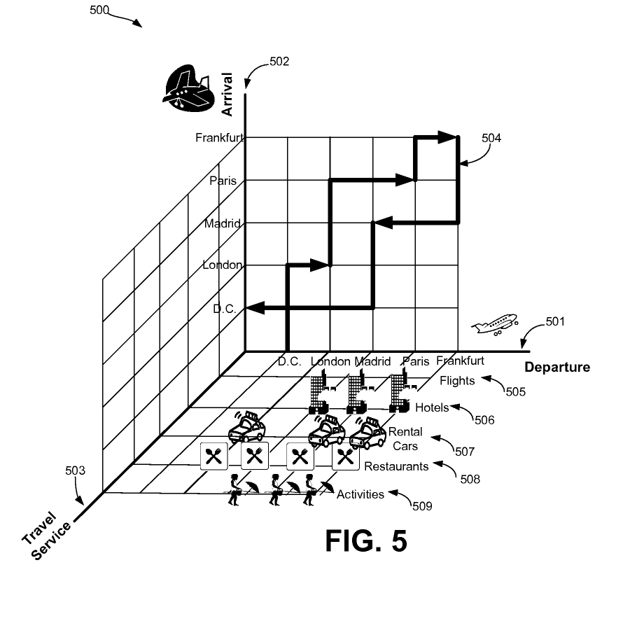

FIG. 5 is a tour detailed 3-Dimensional sequential matrix 500 generated with practical example of the travel service axis 503 matched with the departure axis 501 and the arrival axis 502. When the sequential multi-destination route 504 and flight information 505 are defined, the 3-Dimensional matrix virtual travel agent customizes the travel more detail with travel service axis 503. The travel service provides available reservation information about hotels 506, rental cars 507, restaurants 508, and activities 509 for the traveler. The traveler can easily add or drop the option of travel service for making optimal travel schedule.

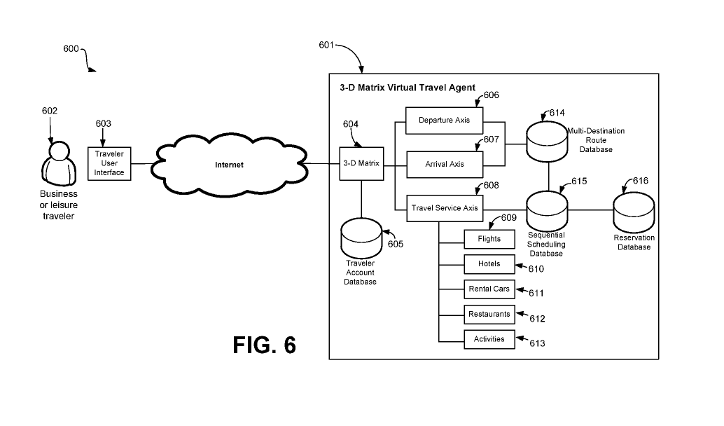

FIG. 6 is a schematic diagram 600 of an exemplary 3-Dimensional matrix virtual travel agent 601 communicating with a user interface 602 through Internet. A business or leisure traveler may use the 3-Dimensional matrix 604 of the virtual travel agent 601 on a user interface 602 through Internet. For the initial stage, the 3-Dimensional matrix 604 requests the traveler general information, and stores it to a traveler account database 605. The 3-Dimensional matrix 604 consists of departure axis 606, arrival axis 607, and travel service axis 608 as default factor.

For the efficient process, a multi-destination route database 614 is linked with both of the departure axis 606 and the arrival axis 607. The multi-destination route database 614 either collects traveler's expected multi-destination route information from the axes 606 and 607 or provides a customized sequential multi-destination route to the 3-Dimensional matrix 604. The travel service axis 608 consists of flights 609, hotels 610, rental cars 611, restaurants 612, and activities 613 as factors, and links with a sequential scheduling database 615. At the same time, the sequential scheduling database 615 collects travel routing information from the multi-destination route database 614. Finally, after deciding all customizing and optimizing travel information with multi-destination travel route, the sequential scheduling database 615 transfers the information to a reservation database 616. The reservation database 616 reserves the all travel services for the traveler, and displays the result on the traveler's user interface 603.

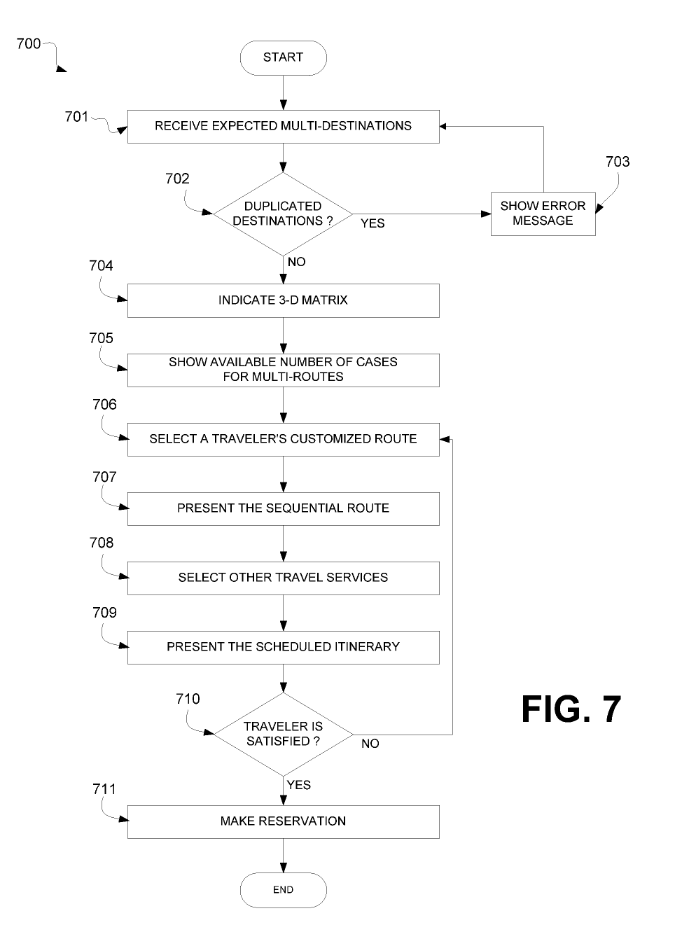

FIG. 7 is a logical flow diagram 700 that depicts the operations which are performed by a 3-Dimensional matrix virtual travel agent. When the process of the 3-Dimensional matrix virtual travel agent is started, the agent received traveler's expected multi-destinations 701 as a multiple travel route through user interface on the agent's Internet Website. The virtual travel agent checks whether the multiple destinations are duplicated or not 702. If the destination cities are duplicated each other, the virtual travel agent displays error message 703 on the user interface and goes back to the initial starting point of the process. Otherwise, the virtual travel agent indicates possible 3-Dimension matrix 704 as an initial stage.

To bring a customized optimal multiple travel destination, the virtual travel agent provides available number of cases 705 for multi-routes on the 3-Dimensional travel matrix. When the traveler selects a customized sequential route 706, the 3-Dimensional travel matrix presents the multi-destination route as visual simulation. If the traveler decides a customized sequential multiple route 707, the 3-Dimensional travel matrix requests travel service option 708 for the traveler to choose. The virtual travel agency presents a scheduled itinerary 709 after the traveler finally decides the sequential multi-destination route and the matched travel service. The virtual travel agency checks traveler's satisfaction 710 about the scheduled itinerary. If the traveler wants to modify the travel schedule, the virtual travel agency always provides another travel schedule simulation, so goes back to the previous process. Otherwise, the virtual travel agency makes reservation 711 all of the travel service including flights, hotels, rental cars, restaurants, and activities. For the end of the process, the virtual travel agency reports the result of the reservation to the traveler on the user interface.

While various embodiments of the present invention have been described above, it should be understood that they have been presented by way of example, and not limitation. It will be apparent to persons skilled in the relevant art that various changes in form and detail can be made therein without departing from the spirit and scope of the invention.

What is claimed is:

1. A system and method for building a 3-Dimensional matrix virtual travel agent to customize sequential multi-destination route trip, the system and method comprising:
presenting a customized multi-destination route on a 3-Dimensional matrix consisting departure cities, arrival cities, and travel services as default axes;
receiving the expected route information of multiple destination travel on behalf of a traveler;
displaying on a 3-Dimensional matrix the available number of cases for the sequential route of the multiple destination travel;
identifying in a multi-destination route database a selection of a traveler's customized sequential route of the multiple destination travel;
storing in a sequential scheduling database a plurality of travel services from a travel service axis using the virtual travel agent operating as a service finder associated with the selection of a traveler's customized sequential multiple travel route;
repeating the possible simulation of a traveler's customized sequential route of the multiple destination travel associated with travel services until a selection of the traveler's customized sequential route has been optimized to build an itinerary of multiple destination travel associated with travel services;
making reservation by a reservation database for the selected travel services; and
displaying the customer's reservation information on the traveler user interface from the 3-Dimensional matrix virtual travel agent.

2. The system and method of claim 1, wherein the 3-Dimensional matrix virtual travel agent is presented on a user interface of travelers through Internet Website.

3. The system and method of claim 1, wherein the 3-Dimensional matrix virtual travel agent stores the traveler's information into a traveler account database.

4. The system and method of claim 1, wherein the multi-destination route database displays the traveler's customized sequential multiple travel route on the 3-Dimensional matrix.

5. The system and method of claim 4, wherein the traveler's customized sequential multiple travel route is a series set of (departure city, arrival city).

6. The system and method of claim 1, wherein the available number of cases for multiple travel routes is (n−1)! when the n is number of travel destination including the initial starting city.

7. The system and method of claim 1, wherein the sequential scheduling database gathers travel service information from travel service axis.

8. The method of claim 7, wherein the travel services include any of flights, hotels, rental cars, restaurants, and activities.

9. The system and method of claim 1, the sequential scheduling database gathers the traveler's customized sequential multiple travel route information from the multi-destination route database.

10. The system and method of claim 1, the reservation database gathers the traveler's customized sequential scheduling information from the sequential scheduling database.
